(19) United States
(12) Patent Application Publication
(10) Pub. No.: US 2026/0141193 A1
(43) Pub. Date: May 21, 2026

(54) CARD READER DEVICE FOR AMUSEMENT AND GAMING MACHINES WITH INSTALLATION, DIAGNOSTIC, AND OFFLINE MODES

(71) Applicant: Amusement Connect LLC, Kansas City, MO (US)

(72) Inventors: John Tarpley, Kansas City, MO (US); Frank Licausi, Kansas City, MO (US)

(73) Assignee: Amusement Connect LLC, Kansas City, MO (US)

(21) Appl. No.: 19/393,254

(22) Filed: Nov. 18, 2025

Related U.S. Application Data
(60) Provisional application No. 63/721,916, filed on Nov. 18, 2024.
(60) Provisional application No. 63/721,922, filed on Nov. 18, 2024.
(60) Provisional application No. 63/721,925, filed on Nov. 18, 2024.

(51) Int. Cl. G06K 7/10

(52) U.S. Cl. CPC G06K 7/10297; G06K 7/10366

(57) ABSTRACT

A card reader device for amusement and gaming machines integrates installation, diagnostic, and offline operational functions within a single hardware platform. The device includes a processor, memory, power-interface circuitry, communication interface, display, indicator assembly, and encryption module. During installation, the device measures network signal strength, provides real-time visual feedback through color-coded indicators, and enables remote configuration via a mobile device or management terminal. In diagnostic mode, the device performs voltage and switching-signal analysis, applies controlled loads, and displays waveform data for verification of wiring and power quality. During network interruptions, the device operates offline using authenticated activation, locally manages transactions, and automatically synchronizes cached data with a central management server upon reconnection. The system reduces installation time, simplifies maintenance, and ensures uninterrupted operation of gaming and amusement machines.

### CROSS REFERENCE TO RELATED APPLICATIONS

This application claims the benefit of U.S. Provisional Application Nos. 63/721,916; 63/721,922; and 63/721,925; each filed on Nov. 18, 2024, the disclosure each of which is hereby incorporated herein in its entirety by reference.

### BACKGROUND

Modern amusement and gaming machines increasingly rely on electronic card readers and electronic payment devices to enable cashless transactions, user authentication, and reporting of operational data to the machine operator. Such card readers and payment devices often provide for wireless network communication, control of power to the gaming machine, and various peripheral interfaces that allow the card reader device to communicate with peripheral devices.

While the current technology of the card reader and payment devices themselves provide a generally compact, reliable solution to accepting card and other electronic payments for gaming machines, the installation and maintenance of such card reader devices remains complex and labor-intensive. During installation, the installers must verify the gaming machine's power supply and signal quality; optimize the placement of the location's network components (such as routers and extenders) to ensure that the card reader device can communicate over the local network; and generally attempt to ensure uninterrupted operation of the card reader device and gaming machine under fluctuating connectivity or power conditions.

In typical scenarios, the installation of a card reader on an amusement or gaming machine requires multiple, independent steps. For example, the installer must manually confirm adequate supply voltage and correct wiring, often using external meters and/or diagnostic tools. Optimization of the local network typically requires repeated adjustment and movement of the wireless access point and/or card reader device position to achieve an acceptable signal strength. Even if properly configured, connected, and with a good network connection, if connectivity to a remote server or cloud service is interrupted, the machine may be rendered temporarily inoperative, resulting in lost revenue and increased service calls.

These difficulties are compounded by the distributed nature of amusement and gaming machine installations, typically having numerous devices deployed across expansive arcades and entertainment centers, each having varying structural, electrical, and network conditions. Installation technicians thus must typically carry specialized equipment to perform installation verification, troubleshooting, and network calibration, often leading to inefficiency and inconsistent results.

Thus, it can be seen that there remains a need in the art for an improved card reader device specifically designed for amusement and gaming machines that overcomes the difficulties with current installation tools and practices, and provides an integrated solution for installers and arcade operators.

### SUMMARY

Embodiments of the invention are defined by the claims below, not this summary. A high-level overview of various aspects of the invention is provided here to introduce certain concepts that are further described in the detailed description section below. This summary is not intended to identify key or essential features of the claimed subject matter, nor is it intended to be used in isolation to determine the scope of the claimed subject matter. Rather, the summary is provided as a convenient reference for understanding the inventive concepts as a whole.

In general, the present disclosure relates to a card reader device or electronic payment device for amusement and gaming machines that integrates multiple operational functions within a single hardware platform. The disclosed system enables installation configuration, power-supply diagnostics, and offline operation through cooperative firmware modules executing on the device and real-time visual feedback through LEDs and displays.

Conventional card reader and electronic payment devices require external tools and manual adjustments to verify network connectivity, voltage quality, and network performance, resulting in lengthy installations and higher maintenance costs. The card reader device of the present invention consolidates multiple installation functions into the device itself, providing automated verification and system configuration using built-in circuitry, software, and communication interfaces.

In one exemplary embodiment, the device includes a processor, memory, communication interface, display module, and power-monitoring circuitry configured to provide the installer with detailed system and operational information during installation. For example, during installation, the device measures Wi-Fi or network signal strength, displays real-time quality indicators through an LED ring or graphical interface, and communicates with a mobile configuration application on a mobile device to assist the installer in achieving optimal placement of the card reader device and/or network access points to provide optimal connectivity.

In another exemplary embodiment, the card reader device provides power-testing and diagnostic functionality that evaluates supply voltage, input and output lines, switching operations, and overall electrical performance. The device may generate graphical or oscilloscope-styled visual depictions of signal waveforms, may apply controlled loads to verify device and system power capacity, and may provide interactive controls to adjust and/or verify signal timing. This diagnostic ability allows rapid verification of proper wiring and voltage levels directly through the card reader device without requiring separate measurement equipment and tools.

In a further embodiment, the device includes the ability to operate offline - i.e., without an active network connection - so that the card reader device and the host amusement machine can continue operating during network or server outages. Offline activation may be triggered by a secure command card or an authenticated or authorized mobile signal, causing the device to temporarily assume local control of transaction management and storage of operational data, which the device automatically synchronizes with a central management server once connectivity is restored.

In other embodiments, multiple card reader devices may be networked across a facility (such as an arcade or amusement center) or a route of amusement machines at various geographic locations. In some embodiments, a remote management server or mobile application may communicate with each card reader device to retrieve diagnostic information, issue configuration commands, or monitor operational metrics and system parameters. The same communication capability further allows real-time display of network signal strength, voltage readings, and operational mode status through a graphical user interface, thus allowing technicians to oversee large installations quickly and efficiently.

Thus, the card reader device of the present invention provides an integrated tool for the installation, configuration, and operation of card reader devices used in amusement and gaming machines.

### BRIEF DESCRIPTION OF THE DRAWINGS

Illustrative embodiments of the invention are described in detail below with reference to the attached drawing figures, and wherein:

FIG. 1 depicts a block diagram a reader device, including a processor, memory, communication circuitry, power input, display and LED indicators, and input/output (I/O) lines in accordance with an exemplary embodiment of the present invention.

FIG. 2 is a flow diagram showing an installation and configuration method of the device of FIG. 1 in accordance with an exemplary embodiment of the present invention.

FIG. 3A is a flow diagram illustrating power-testing and diagnostic functionality of the device of FIG. 1 in accordance with an exemplary embodiment of the present invention.

FIG. 3B is a block and flow diagram illustrating diagnostic and configuration functionality of the device of FIG. 1 in accordance with an exemplary embodiment of the present invention.

FIG. 4A is a flow diagram illustrating offline operation functionality of the device of FIG. 1 in accordance with an exemplary embodiment of the present invention.

FIG. 4B is a diagram depicting network configuration of a plurality of devices of FIG. 1 in communication with a wireless access point in accordance with an exemplary embodiment of the present invention.

FIG. 5A is a flow diagram of the operation of installation, diagnostic, and offline operation of the device of FIG. 1 in accordance with exemplary embodiments of the present invention.

FIG. 5B is a block and flow diagram illustrating an offline operation mode of the device of FIG. 1 in accordance with an exemplary embodiment of the present invention.

FIG. 6 is a block diagram of various display screens of the device of FIG. 1 in various modes of operation in accordance with exemplary embodiments of the present invention.

### DETAILED DESCRIPTION

The subject matter of select embodiments of the invention is described with specificity herein to meet statutory requirements, however the description itself is not intended to necessarily limit the scope of claims. Rather, the claimed subject matter may be embodied in other ways to include different components, steps, or combinations thereof similar to the ones described herein, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

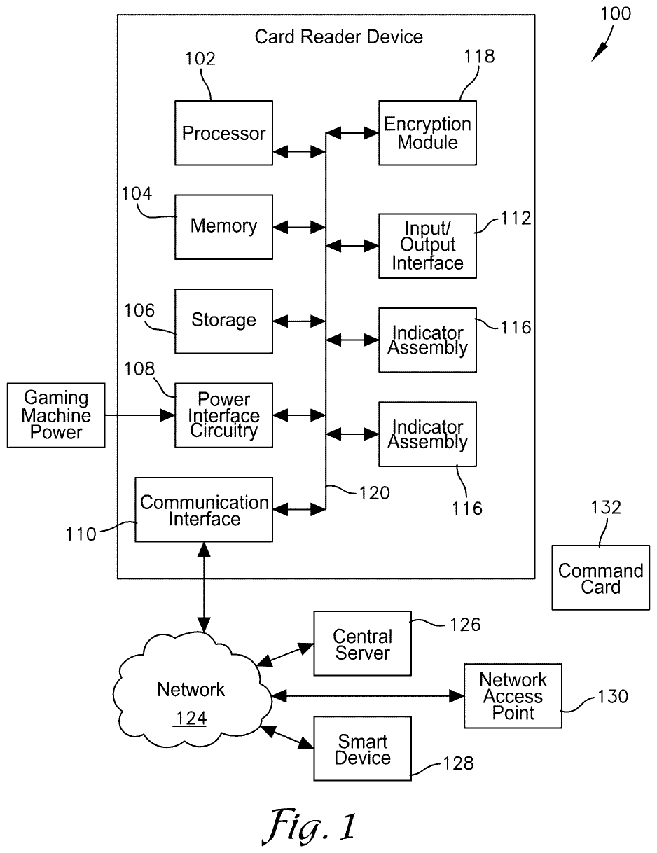

Looking first to FIG. 1, a block diagram of a card reader device 100 for amusement and gaming machines in accordance with an exemplary embodiment of the present invention is depicted. As used herein, a card reader device may include circuitry to read other types of electronic payments, such as payments from smart phones or devices using near-field communication (NFC), radio-frequency identification (RFID) or other electronic payment technologies. The device 100 provides hardware suitable for executing one or more of the software modules, processes, or functions as described herein, including installation configuration, power-supply diagnostics, and offline operation. It should be understood that the components illustrated in FIG. 1 are illustrative and that various configurations, consolidations, or separations of hardware components may be employed without departing from the scope of the invention.

The card reader device 100 includes at least one processor 102 operable to execute computer-readable program instructions that implement the functions described in this disclosure. The processor 102 may comprise a micro-controller, central processing unit (CPU), or a combination thereof, and may include one or more cores configured for parallel or sequential execution of software tasks. The processor 102 is in communication with a memory 104 that provides volatile and/or non-volatile storage for operational instructions to be executed, temporary storage of operational data and parameters, and configuration parameters. The memory 104 may include dynamic random-access memory (DRAM) or static RAM (SRAM) and may store measurement data, network configuration parameters, and operational parameters and variables.

Non-volatile storage 106 provides long-term or permanent storage of program instructions and device configuration data. Storage 106 may include flash memory, electrically erasable programmable read-only memory (EEPROM), or solid-state memory arrays suitable for retaining operational programs and instructions through power cycles. Stored program code defines the firmware modules responsible for installation assistance, voltage and signal diagnostics, and continued operation during network or service interruptions.

As used herein, the term “module” refers to a set of software and/or hardware components configured to perform specific tasks. A module may be implemented as a software application, function, subroutine, library, or service executing on a processor-based computing device, such as a server, desktop, laptop, mobile device, or other computing platform. A module may also be implemented as a combination of software instructions and associated hardware circuitry, such as a field-programmable gate array (FPGA), application-specific integrated circuit (ASIC), or other dedicated processing hardware.

And, as used herein, the term “real-time” refers to the execution of computational processes, including video analysis, parameter selection, and notification at a speed and efficiency that enables immediate interaction without perceptible delay to the user. In this context, “real-time” denotes a level of rapid processing that would be infeasible for a human to perform manually within a practical timeframe.

Power interface circuitry 108 preferably receives electrical power from a host amusement or gaming machine and provides regulated power to the processor 102 and other device circuitry. Power interface circuitry 108 may include input terminals for connection to the host machine's power rail or bus, internal voltage regulators, and monitoring circuitry capable of measuring instantaneous voltage, current, and load characteristics. The power interface circuitry 108 may further include a test circuit or programmable electronic load used during diagnostic routines to determine the available power capacity of the host machine. Measurement outputs from the power interface circuitry 108 are preferably digitized and supplied to the processor 102 for analysis and display.

A communication interface 110 includes circuitry operable to enable the exchange of data and information between the card reader device 100 and external systems. In exemplary embodiments, the communication interface 110 includes circuitry operable to communicate using one or more wireless protocols such as Wi-Fi, Bluetooth®, or near-field communication (NFC) for configuration and payment authorization. The communication interface 110 may further include wired options, such as Ethernet or serial connections, to allow interfacing to older or legacy gaming or amusement machines. Thus, the communication interface 110 allows the card reader device to communicate with a remote management system, a user smart device, a configuration application, or a remote data collection and analytics server. In further embodiments, the communication interface 110 may enable software updates to the card reader device.

An input/output (I/O) interface 112 includes circuitry configured to exchange digital signals and data with the host machine's control electronics. For example, the I/O interface 112 may include switching inputs for coin, ticket, or device access signals, as well as one or more controlled outputs for driving relays, solenoids, or indicator lights. The timing and voltage of any of these signals may be monitored and adjusted under control of the processor 102 to ensure proper integration with a wide variety of amusement machine controllers.

A display module 114 allows the card reader device to convey information to installers and operators. In some embodiments, the display module 114 may comprise an integrated graphical display, segmented display, or other indicator panel, and is preferably capable of presenting numerical values, waveform data, or textual prompts to a user. An indicator assembly 116, such as a multicolor LED ring or array, may be used to provide immediate visual feedback to an installer regarding network signal strength, power status, or operational state of the device. For example, the indicator assembly 116 may illuminate in distinct colors corresponding to “good,” “acceptable,” or “poor” signal strength conditions during installation.

In some embodiments, command and configuration data may be processed by an encryption module 118, which may store cryptographic keys used for authentication of cards used to pay or access the device, encrypted firmware updates, or secure mode transitions such as entry into offline operation. The encryption module 118 may be implemented as a dedicated hardware chip or as a software module running on processor 102.

All components of the card reader device 100 may be interconnected by one or more internal buses 120, which may include parallel buses, serial peripheral interfaces or similar communication links. The bus 120 provides signal and data communication between the processor 102, memory 104, storage 106, power interface 108, and peripheral modules. In some embodiments, the card reader device 100 may further include a housing 122 suitable for mounting the device to the exterior of an amusement or gaming machine with the display 114, indicator 116, and card reader/NFC reader surface presented to the user with the internal circuitry contained within a protective enclosure.

It should be understood that the arrangement and configuration as depicted in FIG. 1 represents a generalized hardware configuration suitable for executing the installation, diagnostic, and offline operation operational modes of the card reader device 100. Variations in the type or processor, power circuitry, or interfaces be employed according to the requirements of the host amusement or gaming machine to which the device is to be used, while remaining within the scope of the present invention.

Looking still to FIG. 1, a smart device 128, such as a phone, tablet, remote PC, or laptop computer, or a central management server 126, may communicate with the card reader device 100, for example, through a network access point 130 and through a local and/or wide area network 124, to allow an installer or other authorized user to communicate with the card reader device to perform various installation and configuration, diagnostics, and offline operation modes as will now be described in more detail. In some embodiments, an installer's authorized command card 132 may be used to initiate secure offline or installer operations.

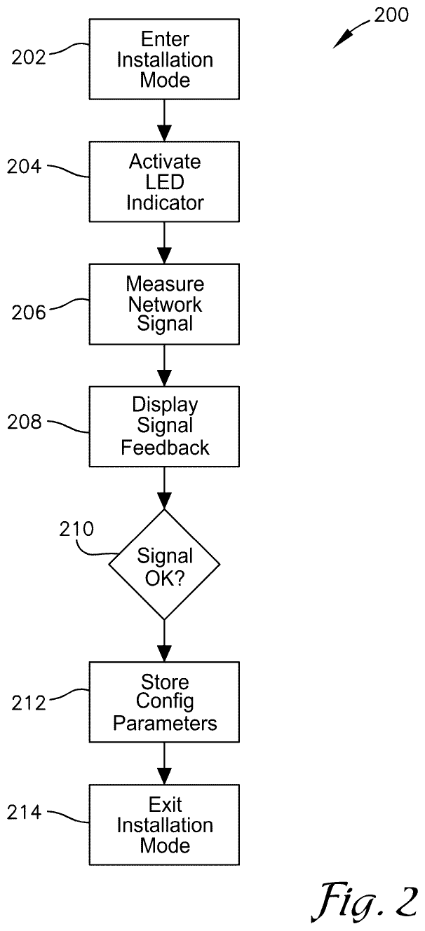

Turning now to FIG. 2, with reference back to FIG. 1, a flow diagram of an installer and configuration mode of operation in accordance with an exemplary embodiment of the present invention is depicted as 200. The installer and configuration mode allows the card reader device 100 to aid an installer in the setup and optimization of the device and facility network connectivity during installation of the card reader device 100 on an amusement or gaming machine.

The installer and configuration functionality is preferably implemented by instructions stored in storage 106 and executed by processor 102, in coordination and communication with the communication interface 110, display 114, and indicator assembly 116 as previously described. The installer and configuration functional mode 200 provides real-time feedback of network signal strength and configuration status directly through the device and/or through a companion configuration interface, such as a smart phone or tablet in communication with the card reader device 100, to allow an installer to complete the installation and configuration using the device itself, or from a corresponding smart phone app, with minimal or no reliance on additional tools or network analysis devices.

Upon power-up of the card reader device 100, or upon selection of an installation command from an installer access card, or from a management terminal or authorized mobile device 128 used by the installer, the card reader device 100 transitions into an installation and configuration mode at block 202 of the flow diagram.

In the installation mode, at block 204 the communication interface 110 initiates a scan for available wireless access points (e.g., network access point 130 of FIG. 1) or local network controllers. The processor 102 preferably, for each detected network, collects parameters such as received signal strength indicator (RSSI), link quality, and latency. These network parameters are preferably updated and analyzed continuously to determine the overall network quality for each detected network.

At block 206, network analysis may include calculating an average or weighted signal score, reviewing packet-loss rate, or reviewing signal interference metrics to provide an aggregated representation of the connectivity and performance of each network.

At block 208, the card reader device 100, using indicator assembly 116 provides visual feedback to the installer corresponding to the measured network quality. For example, in one exemplary embodiment, the LED ring of the indicator assembly 116 illuminates in distinct colors to reflect varying levels of signal strength, e.g., green indicating an optimal network connection, yellow indicating marginal connectivity to a network, and red indicating insufficient signal strength.

In some embodiments, a plurality of card reader devices 100 may be placed into the installer and configuration mode simultaneously through a group command issued from a central management terminal or authorized mobile device 128. Group activation allows an installer to evaluate signal strength and network quality across multiple devices in real time and to reposition one or more network access points 130 to achieve optimal overall coverage.

This visual indication allows an installer to reposition either the card reader device 100 itself, or reposition a network access point 130 and immediately observe the resulting effect on signal quality without additional instrumentation. The display 114 may simultaneously present a numerical value of RSSI or other diagnostic information, allowing finer calibration when necessary.

It should be understood that the installer may be presented with a list of all detected networks and their corresponding network connection quality scores, and may step through the list of detected networks and/or access points and select a desired network for connection. In other embodiments, the card reader device 100 may automatically select the network or access point with the strongest signal, best network connectivity score, or other desired selection criteria.

The mobile device 128 preferably communicates bi-directionally with the card reader device 100 through the communication interface 110 using a secure pairing and communication protocol. Thus, using an application or system management console (e.g., a PC or server), an installer can view detailed configuration data, including network identifiers, encryption settings, and signal-strength history captured over time. The mobile interface may also display a graphical progress bar or real-time chart of signal quality as the installer adjusts the machine's placement and/or antenna orientation. Once an acceptable threshold is achieved, the installer may command the device 100 to store the selected network credentials in non-volatile storage 106, completing the network-configuration process.

In some embodiments, the installer function 200 may provide further capabilities, such as reporting the firmware version, device identification, and environmental diagnostics such as temperature or voltage and current monitoring. The same configuration interface may also allow the installer to perform a hardware test sequence that flashes the indicator 116, verifies the operation of the display 114, and confirms that the communication interface 110 is functioning correctly. These functionality checks ensure that the card reader device 100 is properly installed and capable of reliable communication before the gaming or amusement machine is placed into operation.

The installation and configuration mode 200 thus provides both visual and analysis feedback to allow an installer to streamline setup and installation of the card reader device 100 in varying operating environments. By integrating network signal strength measurement, color coded indication lights, and remote configuration within a single operational mode, the invention eliminates the need for external meters or repeated manual adjustments.

The installation mode thus ensures that the card reader device in each amusement or gaming machine is deployed with confirmed network connectivity, thus reducing installation time, minimizing service calls, and ensuring stable operation once the machine is placed into regular use.

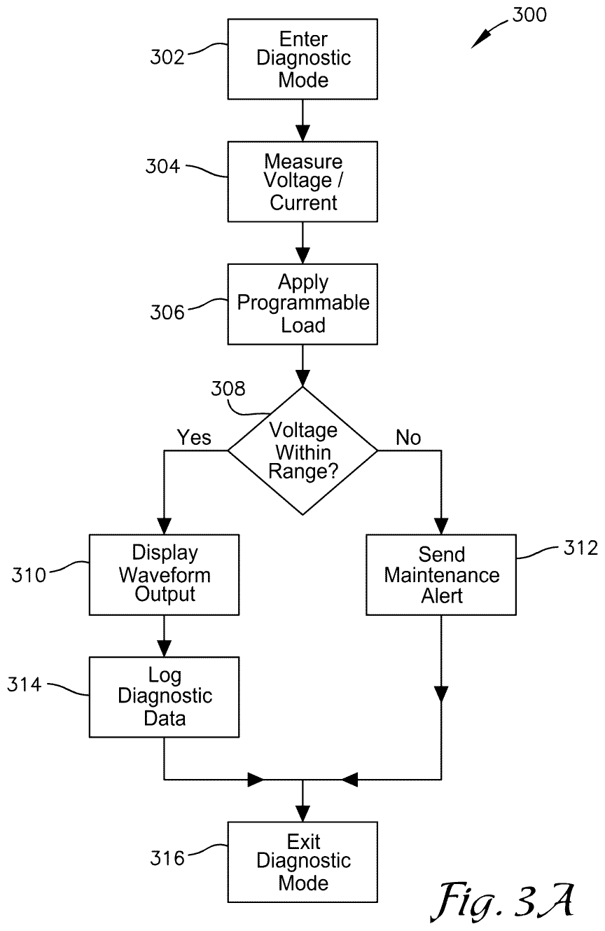

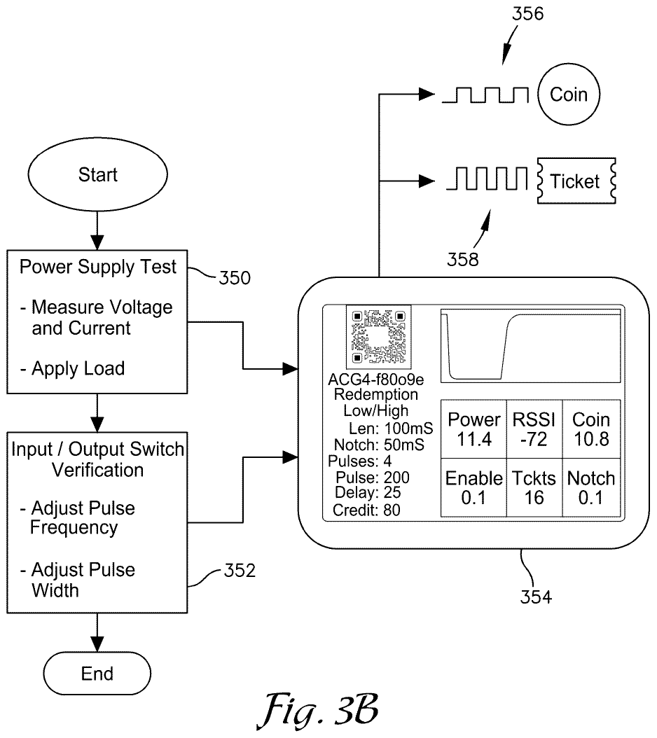

Turning now to FIG. 3A, a flow diagram of a power testing and diagnostic mode of operation of the card reader device 100 is shown in accordance with an exemplary embodiment of the present invention as 300. Power testing and diagnostic mode 300 enables the card reader device 100 to evaluate the electrical quality and connectivity of the power supply and switching lines connected to the gaming machine during installation or maintenance of an amusement or gaming machine, or deployment of a card reader device 100 to an existing gaming machine.

The power testing and diagnostic mode 300 is executed by the processor 102 under control of instructions stored in the storage 106, operating in conjunction with the power interface 108, the input/output interface 112, and the display 114. The diagnostic capability allows an installer or technician to verify proper wiring, voltage levels, and signal behavior without requiring external test instruments.

At block 302, the processor 102 initiates a power supply evaluation sequence upon user command (e.g., by an installer) or other entry into diagnostic mode. The power interface 108 preferably measures the incoming supply voltage and current provided or available from the host gaming machine's power rail or wiring harness. The measured values are compared to stored threshold ranges corresponding to acceptable operating limits. If the voltage falls outside the allowable range, the device 100 may generate a visual warning on the display 114 and illuminate the indicator assembly 116 in a distinctive color pattern to alert the installer to a potential wiring or power supply issue. The processor 102 further records the measured data in memory 104 for later review through a mobile configuration interface.

At block 304, the processor 102 activates an internal load test by enabling a controlled electronic load within the power interface 108. For example, the power interface may connect a resistive, inductive, and/or capacitive load to the power supply input and measure the voltage, current, and other parameters. The load is preferably applied to the power supply for a defined period of time to determine the available power capacity of the host machine's power supply. Parameters such as voltage sag, current response, and recovery time are measured to ensure that the power supply can sustain operation of the card reader and any peripheral loads, such as lights, ticket dispensers, or coin-handling equipment. The resulting voltage, current, and/or wattage data are displayed in real time on the display 114, providing an immediate quantitative assessment of the power supply's capacity to the installer.

In some embodiments, at block 306, the processor 102 performs signal line verification. In operation, the input/output interface 112 monitors the voltage levels present on two switching inputs and at least one switching output, for example, each corresponding to coin, credit, or ticket control lines on the host machine. The processor 102 samples and measures these signals and displays their real time states graphically and/or numerically on the display 114.

In one embodiment, the display 114 presents an oscilloscope type waveform depicting pulse timing, signal rise and fall, and duty cycle of the one or more control signals. The waveform display allows the installer to confirm that the input and output lines are properly connected and responding at the expected voltage and timing levels.

At block 308, the device 100 may perform a commanded signal test by transmitting controlled pulses from an output line and observing the corresponding input responses. The processor 102 evaluates the success or failure of each commanded pulse and provides immediate visual or textual confirmation on the display 114. This mode of operation allows verification of correct wiring polarity and communication between the card reader and the amusement machine's control board. The installer can thus confirm the integrity of the electrical connections and the responsiveness of the system before enabling live operation of the machine.

At block 310, the processor 102 provides interactive adjustment controls to allow modification of system control signals, such as pulse frequency, duration, or amplitude. Similarly, using the configuration interface or the onboard controls, the installer may, for example, increment the number of pulses sent or alter the pulse rate to simulate normal operational loads and control signals. The display 114 preferably updates dynamically, in real time, to show measured voltage transitions and switching accuracy.

The diagnostic mode thus allows monitoring of system voltages, currents, control signals, and other parameters, and further allows fine-tuning of machine parameters such as ticket payout rate or the timing of coin and/or credit recognition.

Upon completion of the diagnostic sequence, the processor 102 preferably compiles a summary of the results, including voltage values, current values and capacity, signal timings, and any detected anomalies, and stores them in the storage 106. The collected data may be transmitted through the communication interface 110 to a mobile device or central management system for recordkeeping or technical support analysis.

As just described, the diagnostic mode significantly reduces installation and setup time of a card reader device in a gaming machine, and eliminates the need for external equipment such as volt meters or oscilloscopes, while ensuring consistent standards are applied across all installations. By embedding diagnostic and signal-analysis capabilities within the card reader device 100, the present invention thus improves the serviceability and reliability of the installation, thus minimizing down time.

Turning to FIG. 3B, a further illustration of the diagnostic and installation mode, with input/output switch verification and confirmation of amplitude, pulse frequency, and pulse width settings, for example with respect to output pulse trains for driving a coin or token dispenser, or for driving a ticket dispenser to provide users with reward tickets.

As seen in FIG. 3B, a card reader device, such as the device 100 described above with respect to FIG. 1, is depicted as 354. At block 350, in a power supply test mode the device 354 display (as depicted) may display power, voltage, current, or other parameters. At block 350, in an input/output switch verification mode, the device display may include an oscilloscope type display of pulses generated by the device 354, and allow an installer to adjust and view the pulse frequency, pulse width, and pulse amplitude of pulses to allow calibrating the device 354 for communicating with and driving coin payout 356 or ticket redemption 358 devices, as well as any other devices the card reader device 354 may be interfaced with.

The integrated display of the device 354 thus allows a service technician or installer to monitor and adjust input and output switch parameters as desired without the need for external equipment such as an oscilloscope, volt meter, or other equipment and tools.

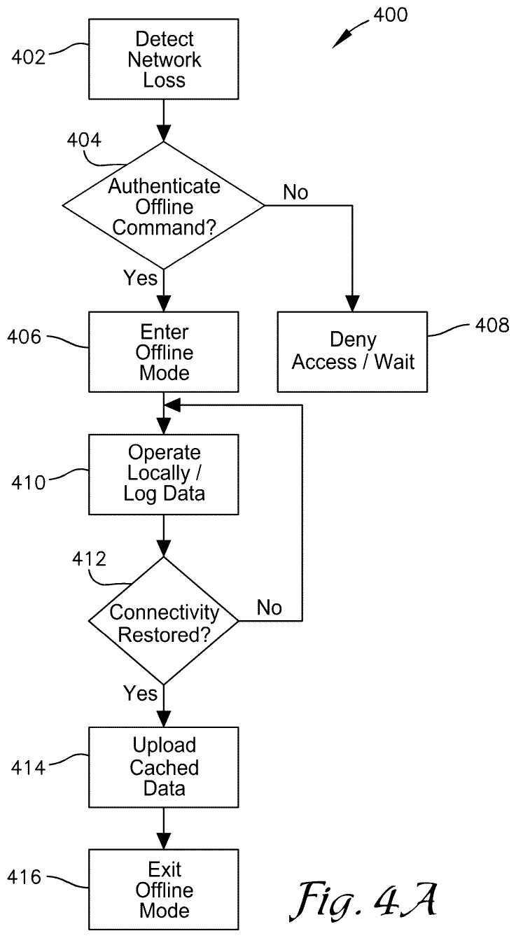

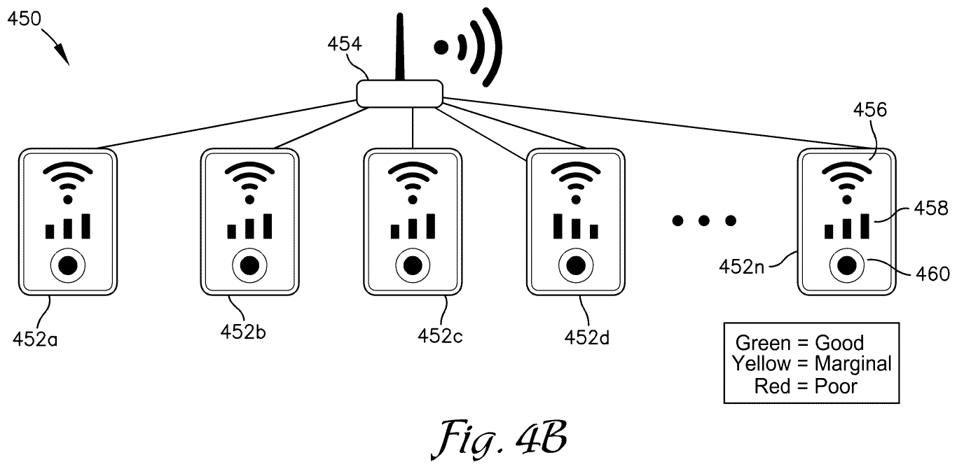

Referring now to FIG. 4A, a flow diagram of an offline operation mode of the card reader device 100 in accordance with an exemplary embodiment of the present invention is depicted as 400. Offline operation mode 400 allows the card reader device 100 to maintain continuous operation of the amusement or gaming machine when connectivity to a network, server, or cloud service is lost—i.e., the card reader device is offline. This functionality ensures uninterrupted gameplay, credit management, and user interaction even during temporary communication outages, thereby preventing downtime and loss of revenue.

In operation, offline operation mode 400 is executed by the processor 102 in coordination with the communication interface 110, encryption module 118, and power interface 108, and is preferably controlled through authenticated commands received from an authorized command card 132 or mobile device.

At block 402, the processor 102 continuously monitors the status of the network connection through the communication interface 110. Diagnostic parameters such as link integrity, packet-loss rate, and response latency are preferably measured periodically and compared to predefined thresholds. If the monitored parameters indicate that the connection to the remote central management server system or cloud service has been lost, or has degraded below an acceptable threshold, the processor 102 automatically transitions the device 100 into a standby state while awaiting further instruction. During the standby state, and during a transition to offline mode (as will be described below), all in-progress transactions or game-related credit records are securely cached in the memory 104 and/or storage 106 to prevent data loss.

At block 404, an activation signal to instigate offline operation mode is received and authenticated. The signal may originate from an authorized command card 132 (i.e., a card identified as having installer or supervisor privileges), a mobile device 128 using near-field communication (NFC), or another secure credential recognized by the encryption module 118.

Upon successful authentication, at block 406 the processor 102 switches the device 100 into an offline state. In the offline state, local software/firmware logic replaces remote authorization functions that would normally depend on server connectivity. Thus, in offline mode, the device 100 continues to read player credentials, issue credits, and/or perform machine-specific functions using locally stored rules and encryption keys. The encryption module 118 ensures that only authorized command sources can initiate or terminate offline operation, thus preventing unauthorized manipulation of the system.

At block 408, while operating in offline mode, processor 102 periodically runs network polling routines to detect the return of network connectivity. In some embodiments, the communication interface 110 may attempt background reconnection at scheduled intervals or upon detection of network signals exceeding the stored threshold. The frequency of polling or retesting network connectivity may be adjusted in real-time based on measured power conditions reported by the power interface 108, thus reducing unnecessary activity during extended power outages to conserve energy.

At block 410, the processor 102 continues to manage normal reader functions, including acceptance of payment cards and other electronic payments, tracking of credits, and communication with the host gaming machine through the input/output interface 112. Locally stored transaction data is encrypted and stored in the storage 106 for later upload once network connectivity is restored. Display 114 and indicator assembly 116 preferably provide distinct visual feedback to the operator indicating that the device is operating in offline mode, for example, by flashing a specific color pattern or displaying an “OFFLINE MODE ACTIVE” message.

At block 412, when the processor 102 detects network connectivity has been re-established, the device 100 automatically transitions to an online-restoration mode where any cached transaction data, diagnostic logs, and any configuration updates recorded while offline are transmitted through the communication interface 110 to the remote management system. The encryption module 118 preferably verifies the integrity of the transmitted data and confirms successful synchronization before returning the device 100 to its normal operational mode. In preferred embodiments, the return to online mode occurs automatically upon detection of network connectivity, thus allowing a seamless transition for users of the gaming machine and operators of an arcade. In some embodiments, the transition to online operation may require an authorized user, such as an installer, to initiate the transition back to online mode.

In further embodiments, offline mode 400 may include configurable parameters defining the maximum allowable time that offline mode may be in operation, limiting the number of local credits allowed during offline mode, or other specific operational restrictions or permissions while in offline mode. These parameters may preferably be adjusted through the installer or diagnostic interfaces described previously, allowing site operators to adjust offline behavior according to venue policies or regulatory compliance requirements. In further embodiments, offline mode 400 may also initiate controlled power-management adjustments through the power interface 108, such as reducing display brightness or lowering processor clock speed to conserve energy during extended service disruptions.

Through the offline operational function 400, the card reader device 100 provides a self-contained continuity mechanism that allows amusement and gaming machines to remain fully functional in the absence of network connectivity. By authenticating offline activation, securely caching transaction data, and automatically restoring normal operations upon reconnection, the invention ensures both operational reliability and data integrity across network-dependent amusement environments.

Looking to FIG. 4B, a plurality of card reader devices 452a through 452n, such as card reader device 100 as described above in a network configuration mode are depicted as 450. In this mode, each device may display a signal strength 456 or network connectivity value 458 in graphical form, showing the device's connectivity with a wireless access point 454. Using just the display on the device, without requiring any additional signal strength meters or measurement equipment, an installer may determine the signal strength and connectivity of each device just by referring to the display screen of the device. In preferred embodiments, the display may include an LED type display element 460 (or in some embodiments, the device may include an LED) that provides a green/yellow/red indicator of signal strength and connectivity with the wireless access point, indicating good, marginal, or poor connectivity, respectively.

As can be seen in FIG. 4B, an installer may view the displays of multiple devices 452a through 452n at once, and, for example, move the physical location of the wireless access point 454 in order to find a location where all devices have good, or acceptable, connectivity with the access point. Or, in some case, the installer may move the physical location of device 452, or a machine in which the device is installed, to achieve a desired connectivity level.

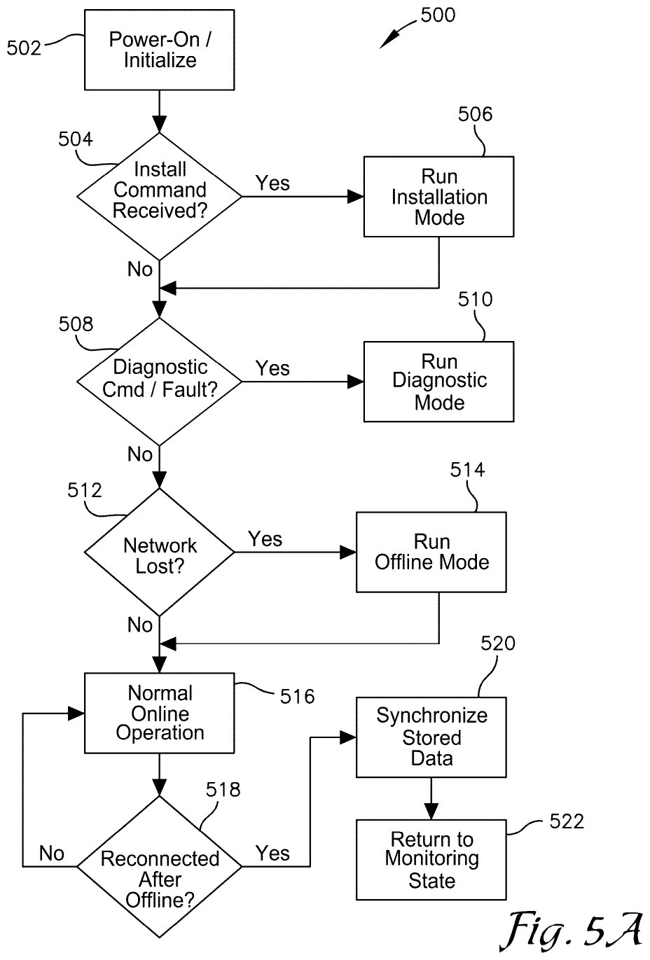

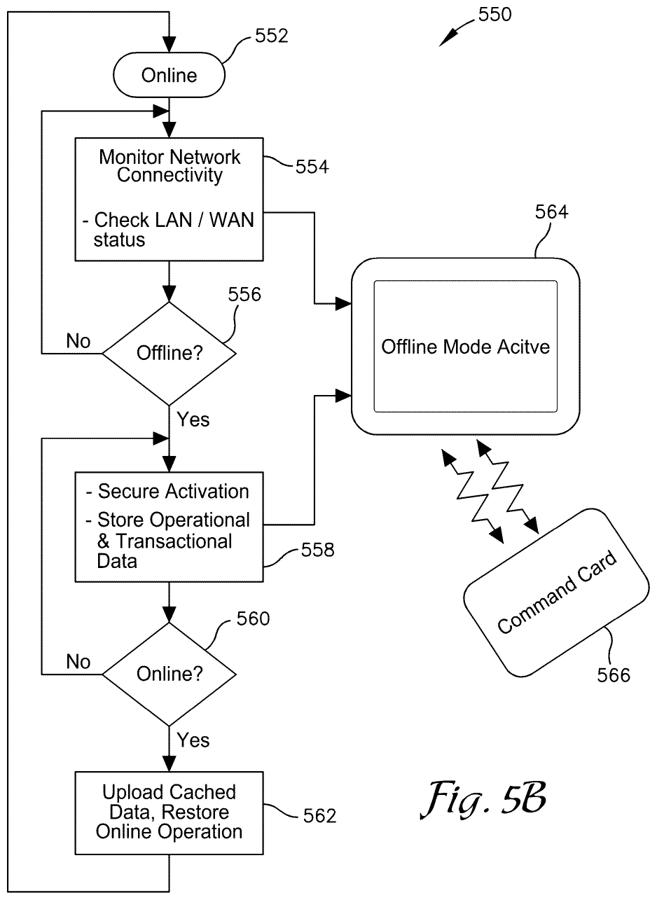

Turning now to FIG. 5A, a flow diagram of an exemplary operation of a card reader device 100 in accordance with an exemplary embodiment of the present invention is depicted as 500. The process 500 illustrates the overall sequence of operation of the card reader device performing its installation and configuration, diagnostic, and offline operation modes. The depicted flow represents the logic executed by the processor 102 executing instructions from memory 104 (and stored in storage 106), with data exchanged through the communication interface 110, power interface 108, and input/output interface 112.

At block 502, the card reader device 100 is powered and initialized. The power interface 108 verifies that incoming voltage and current levels are within acceptable operating limits, as previously described with reference to FIG. 3A. With power supply stability confirmed, at block 504 the processor 102 loads stored configuration parameters from the non-volatile storage 106 and initializes the device for connection to a network or a management terminal. During this step, the indicator assembly 116 may display a specific color pattern signifying successful boot and readiness for installation or operation.

At block 506, the processor 102 determines whether the card reader device is operating in an initial deployment state (i.e., a new device) or a previously configured state (i.e., a device already installed). If the device is newly deployed or has been reset, the process moves to block 508, where the installer and configuration mode described with respect to FIG. 2 above is invoked. At block 510, the device performs a network scan, communicates with a mobile device 128 or a management terminal as previously described, and displays real-time signal strength via display 114 and indicator 116. Once the selected network and configuration parameters are confirmed, the device securely stores the settings in the storage 106 and exits the installation routine.

At block 512, the processor 102 performs an automated diagnostic self-check using the power-testing and signal-verification procedures described with reference to FIG. 3A above. The device measures voltage levels, evaluates switching inputs and outputs, and confirms correct electrical connectivity to the host amusement or gaming machine. If any anomalies are detected, such as insufficient voltage or mis-wired signal lines, the processor 102 may flag the condition for display on the interface screen or configuration display or transmit a maintenance alert to a management central server. If the diagnostic checks pass, the device transitions to a normal operational state.

At block 514, the device enters normal online operation, conducting payment authorizations, credit tracking, ticket count, or other amusement-machine control functions while maintaining continuous communication with an installer's mobile device 128 or a central management server. Operational data such as voltage, temperature, and network metrics are periodically logged in memory 104 and/or storage 106 and reported to a central management server for monitoring and analytics. During this time, the device may receive periodic configuration updates or firmware revisions from the server, which are authenticated through the encryption module 118 before installation.

At block 516, the processor 102 monitors network integrity to determine whether a connectivity loss has occurred. If the network remains stable, the process continues its normal, online operation. If communication is interrupted beyond a predetermined duration or fails authentication checks, the process proceeds to block 518, where the offline operation mode of FIG. 4 is activated. A secure command card (such as an installer's card) or a mobile authorization signal may also manually trigger the transition to offline mode when required by an operator. In offline mode, the device continues performing its critical functions using locally stored credentials and policies, caching all transactions for later synchronization as described above.

At block 520, the device conducts background network polling to detect restoration of network service. When network connectivity is detected and verified by the encryption module 118, the process proceeds to block 522, where cached transaction and diagnostic data are uploaded to a management server for coordination and reconciliation. The system then confirms successful synchronization and returns automatically to normal online operation at block 514. This seamless transition back to online mode ensures uninterrupted gaming play for players and operators while preserving data integrity across the network.

Looking to FIG. 5B, a further depiction of the operation of a card reader device 564 in an offline mode is depicted generally as 550. As seen in the figure, at block 552 the device 564 is initially installed and in an online, connected state. At block 554 the connectivity is verified, confirming that the device is still in communication with a local or wide-area network. At block 556, if the device is detected to be offline (i.e., no network connectivity), then at bock 558 the device 564 indicates on its display that it is offline. Once offline, an arcade operator, installer, or technician, using a command card 566 or handheld smart device (as will be described below) may command the device 564 to activate in offline mode to allow users to continue to use the device to activate and play the gaming machine. In offline mode, as shown in block 558, all operation and transactional data is securely stored on the device itself.

At block 560, while in offline mode, the device 564 continually monitors the network connectivity to see if the network connection has been restored. If not, the device continues to operate and store operational and transactional data at block 558.

Once network connectivity is restored, at block 562 all of the operational and transactional data stored during offline mode operation is transmitted to the same central server or other location as in normal operation. Furthermore, once connectivity is re-established, the device automatically reverts to online operation without any intervention required by an installer, technician, or arcade operator.

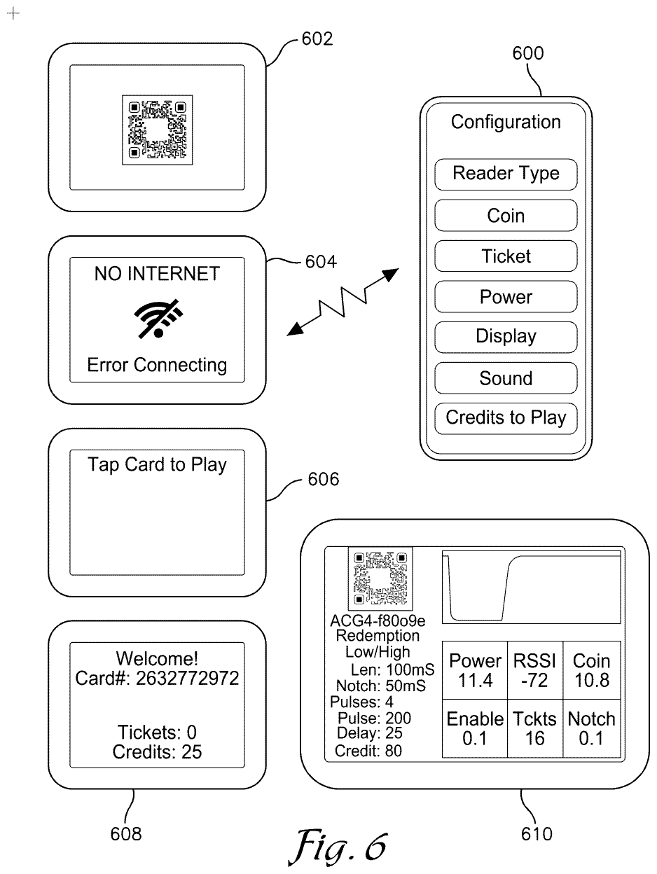

Turning to FIG. 6, exemplary display screens 602, 604, 606, 608, and 610 associated with the various modes of operation of the card reader device of the present invention are depicted, along with an exemplary display of a user smart device 600 operable to communicate with the card reader device.

As seen in the figure, a user device 600 may be configured to connect to the card reader device over a network wired or WiFi connection, to allow an installer, technician, or arcade operator access the device for configuration (as depicted) or for other interaction with the device. In some embodiments, in the absence of network connectivity the smart device may be configured to communicate via other means, such as over a Bluetooth connection.

As depicted in display 602, in some embodiments and modes of operation, the device may display a QR Code or other graphical code to allow a user to scan the code, using a smart device 600, to access machine information and/or to enable connection and communication with the device, and in some embodiments to allow a technician to instigate offline operation mode.

As shown in display 604, in the event the device loses network connectivity, as described above, the display may display a “NO INTERNET” or “no connectivity” message.

Display 606 shows a normal operational mode for the device, with the screen inviting a user or customer to tap their access card to play. Display 608 depicts a welcome screen presented to the user upon tapping their card, showing their user/card/account number and the number of tickets (or other awards) accumulated by the user, and the number of credits for play the user has remaining.

And, as discussed above, an installation screen allows an installer or technician to monitor and adjust various parameters of the device for installation, operational, or troubleshooting purposes without requiring additional external equipment or tools.

Thus, it can be seen that the card reader device described herein provides an integrated and highly efficient solution for the installation, operation, and maintenance of amusement and gaming machines. By combining multiple functions and modes of operation within a single hardware platform, the card reader device allows installers and operators to perform network optimization, power verification, and operational continuity without external diagnostic tools or additional hardware.

The invention is particularly well suited for use in route-based or arcade environments where multiple gaming or amusement machines are networked under a centralized management system. The card reader device's self-diagnostic and offline capabilities reduce service interruptions and ensure that each connected machine continues to operate even when network or cloud connectivity is unavailable.

Embodiments of the claimed technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. A card reader device for an amusement or gaming machine, comprising:
a processor;
a memory storing program instructions executed by the processor;
a power interface circuit configured to receive power from the gaming machine and to measure voltage and current characteristics of the received power;
a communication interface configured to exchange data with a network and with a mobile device or central management server;
a display and an indicator assembly configured to present visual feedback; and
an encryption module configured to authenticate commands and secure stored information;
wherein the processor is configured to:
(a) execute an installation mode that measures network-signal strength through the communication interface and provides real-time visual feedback through the indicator assembly;
(b) execute a diagnostic mode that controls the power-interface circuit to evaluate voltage and switching-signal characteristics of the gaming machine and to present corresponding diagnostic information on the display; and
(c) execute an offline-operation mode that, upon detection of loss of network connectivity, securely stores operational data in the memory and subsequently synchronizes the stored data with the management server upon restoration of connectivity.

2. The card reader device of claim 1, wherein the processor is further configured to receive a group-activation command from the central management server or an authorized mobile device to simultaneously place a plurality of card reader devices into installation mode.

3. The card reader device of claim 1, wherein the indicator assembly comprises a multicolor light-emitting-diode ring that illuminates in distinct colors corresponding to levels of network-signal quality.

4. The card reader device of claim 1, wherein the display is configured to present a numerical value of received-signal-strength indication (RSSI) during installation mode.

5. The card reader device of claim 1, wherein the diagnostic mode includes applying a controlled electronic load to the gaming-machine power rail and measuring resulting voltage sag and recovery time.

6. The card reader device of claim 1, wherein the display presents an oscilloscope-style waveform depicting timing and duty cycle of at least one switching signal.

7. The card reader device of claim 1, wherein the processor is further configured to transmit a maintenance alert through the communication interface to the central management server when a diagnostic anomaly is detected.

8. The card reader device of claim 1, wherein the offline-operation mode is initiated by authentication of a secure command card verified by the encryption module.

9. The card reader device of claim 1, wherein the offline-operation mode includes limiting a duration of offline activity or a number of credits processed during offline operation.

10. The card reader device of claim 1, wherein the processor automatically transitions among the installation, diagnostic, and offline-operation modes based on received installer commands or detected network or power conditions.

11. The card reader device of claim 1, wherein operational data comprises at least one of voltage, temperature, and network metrics recorded during operation.

12. The card reader device of claim 1, wherein the communication interface is further configured to receive authenticated firmware updates from the management server for installation by the processor.

13. The card reader device of claim 1, wherein the power-interface circuit comprises a programmable electronic load used to test power-supply capacity of the gaming machine.

14. The card reader device of claim 1, wherein the encryption module authenticates offline-mode exit and data-upload operations prior to resuming online connectivity.

15. The card reader device of claim 1, wherein the processor, memory, and power-interface circuit are housed within a single enclosure mountable to an exterior surface of the gaming machine.

16. A method of operating a card reader device coupled to an amusement or gaming machine, comprising.

17. The method of claim 16, further comprising simultaneously placing multiple card reader devices into the installation mode through a group command from a management terminal.

18. The method of claim 16, further comprising initiating the offline-operation mode by authentication of a secure command card.

19. A system comprising.

20. The system of claim 19, wherein the central management server is further configured to transmit group-activation commands to simultaneously initiate installation mode in the plurality of card reader devices.
